(19) United States
(12) Patent Application Publication
(10) Pub. No.: US 2011/0127910 A1
(43) Pub. Date: Jun. 2, 2011

(54) High-pressure discharge lamp

(75) Inventors: Joachim Arndt, Brieselang (DE); Uwe Fidler, Berlin (DE); Ralph Hauschild, Beelitz (DE)

(73) Assignee: OSRAM GESELLSCHAFT MIT BESCHRAENKTER HAFTUNG, Muenchen (DE)

(21) Appl. No.: 12/952,233

(22) Filed: Nov. 23, 2010

(30) Foreign Application Priority Data
Dec. 1, 2009 (DE) 10 2009 047 339.4

(51) Int. Cl. H01J 61/18

(52) U.S. Cl. 313/638

(57) ABSTRACT

In various embodiments, a metal halide discharge lamp is provided, which may include a ceramic discharge vessel containing a metal halide fill, including a tubular central part and two end sections which are configured asymmetrically, in each of which an electrode system is held, wherein a pointed first end section tapers as seen from the central part, while a blunt second end section either remains constant in its dimensions or widens as seen from the central part, a stopper being fitted at least in the blunt end.

### CROSS-REFERENCE TO RELATED APPLICATION

This application claims priority to German Patent Application Serial No. 10 2009 047 339.4, which was filed Dec. 1, 2009, and is incorporated herein by reference in its entirety.

### TECHNICAL FIELD

Various embodiments are based on a high-pressure discharge lamp. They are, by way of example, high-pressure discharge lamps including a ceramic discharge vessel and a metal halide fill.

### BACKGROUND

EP 1 652 212 and WO 2006/081804 disclose a reflector lamp which uses a fitted lamp base on a ceramic discharge vessel having a metal halide fill.

In metal halide reflector lamps without a dazzle protection system, which are equipped with round or oval bulbs, a part of the light shines into the reflector neck and is lost there owing to the typically steep incidence angle. A narrow neck diameter, reflector faces additionally introduced into the neck opening but also cylindrical bulb geometries have a positive effect on the light loss through the neck opening. Color inhomogeneity due to the fill pool in the bulb can to some extent be compensated for by suitable reflector curves. Likewise, structured reflector cover disks mix the light with different spectra and thus homogenize the color distribution.

In reflector lamps with a dazzle protection system, the fraction of light shining into the dazzle protection cap is negated by an absorbent surface in order to reduce radiation back onto the seal region of the bulb. All mechanisms mentioned here may also be encountered similarly in lights with and without a dazzle protection system, which are equipped with metal halide lamps.

### SUMMARY

In various embodiments, a metal halide discharge lamp is provided, which may include a ceramic discharge vessel containing a metal halide fill, including a tubular central part and two end sections which are configured asymmetrically, in each of which an electrode system is held, wherein a pointed first end section tapers as seen from the central part, while a blunt second end section either remains constant in its dimensions or widens as seen from the central part, a stopper being fitted at least in the blunt end.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a ceramic discharge vessel, which is constructed asymmetrically, in section (FIG. 1a) and perspective (FIG. 1b);

FIG. 2 shows a reflector lamp having such a discharge vessel;

FIG. 3 shows a reflector lamp having such a discharge vessel;

FIG. 4 shows another embodiment of a ceramic discharge vessel in section (FIG. 4a) and perspective (FIG. 4b); and

FIG. 5 shows another embodiment of a reflector lamp including the discharge vessel of FIG. 4.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a lamp interacting with a reflector, which has a high efficiency based on a ceramic fitted lamp.

In known metal halide reflector lamps, e.g. reflector lamps with a dazzle protection system, a large part of the light emitted by the bulb is lost since it neither strikes the active reflector surface directly nor is emitted directly in the useful direction. Owing to this effect, some of the otherwise very good efficiency of round bulb geometries is negated. In designs dimensioned to the limit values in terms of power, this entails a high risk of failure due to thermal overloading. Furthermore, the perturbing effect of color inhomogeneities of an illuminated surface is known for metal halide reflector lamps. This applies above all with a horizontal operating position, owing to the selective color transmission of light radiation emitted from the discharge arc through the metal halide fill pool.

This effect is stronger when the bulb geometry reinforces accumulation of the fill pool in the main beam path. This is precisely the case with round or oval bulb shapes. All these mechanisms can also occur in lights which are equipped with metal halide lamps, irrespective of whether a reflector is used or whether the reflector is mounted separately from the lamp.

According to various embodiments, the ceramic discharge vessel is composed of a central part, which e.g. is cylindrical, and two ends. These ends are configured asymmetrically. The first end essentially keeps the diameter of the central part. It is closed in a known fashion by a stopper. The second end tapers to a capillary. In various embodiments, the tapering end section is shaped as a half-bowl, e,g, hemispherically or as a sphere segment, or as an ellipse segment.

In various embodiments, the ceramic discharge vessel has a conical shape and two stoppers, in which case the cone side may be a circle segment, a parabola segment or a freeform line.

The capillaries with the electrode feed-throughs are located at the stoppers.

The stopper has e.g. a greater wall thickness WDS than the bulb body, the wall thickness of which is denoted by WDK.

The bulb itself may be made in one part or include several parts.

Owing to the possible features described above, there are various embodiments. By way of example, the lamp may be a reflector lamp or a metal halide lamp with an asymmetric bulb in a light.

The emission for reflector lamps may be optimized by suitable shaping of the bulb body. Furthermore, the formation of color inhomogeneities can be reduced by forming a cold spot which does not lie in the main beam path of the light. In MH reflector lamps without a dazzle protection system, a ceramic including a stopper, which is oriented toward the reflector neck, can reduce the radiation into the neck and keep the condensate outside the desired emission region. Toward the reflector opening, an end section of the bulb ceramic is formed conically, ovally or as a freeform line adapted to the reflector contour, in order to permit maximally homogeneous emission into the useful region of the reflector.

In reflector lamps with dazzle protection systems, such a bulb ceramic may be mounted with the stopper in the direction of the dazzle protection. The advantages for the reflector neck region, however, may thereby be lost.

Another embodiment is a bulb ceramic which includes two stoppers and a discharge body, which corresponds to a sphere segment, a cone with a parabolic curve or a freeform line. The radiation loss into the reflector neck and dazzle protection system can be reduced by means of this, so that a cold spot is formed outside the main radiation region.

The following parameters may be improved by the described design: efficiency of reflector lamps, reduction of thermal failures, higher lamp power with the same structure, omission of nitrogen fills in the outer bulb of component lamps, homogeneity of the color distribution in the emission direction, homogeneity of the light distribution in the emission direction.

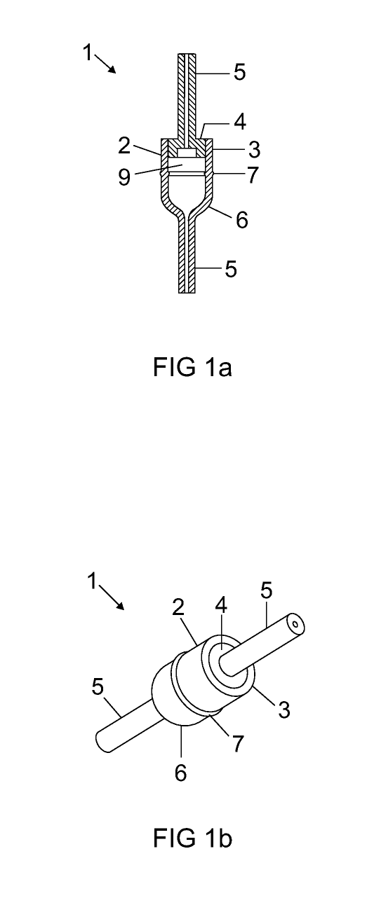

FIG. 1 shows a metal halide lamp. It is a 70 W lamp including a ceramic discharge vessel 1.

The bulb ceramic 1 is composed of a cylindrical central part 2 and two end sections. The blunt first end section 3 keeps the constant diameter of the central part and is closed by a stopper 4. The latter may be sintered in directly or bonded by means of glass solder. A capillary 5 follows on integrally or separately from the stopper 4. The second end section 6 converges in a pointed fashion and likewise tapers into a capillary 5. The shape of the pointed second end section 6 is that of a sphere segment. In the specific case, it is a spherical half-bowl.

The shape of the second end section 6 may however also be that of an ellipse segment, or partially elliptical, or that of a hemisphere segment.

For the sake of simple production, the discharge vessel is composed of two parts, which are joined together by means of a central seam 7.

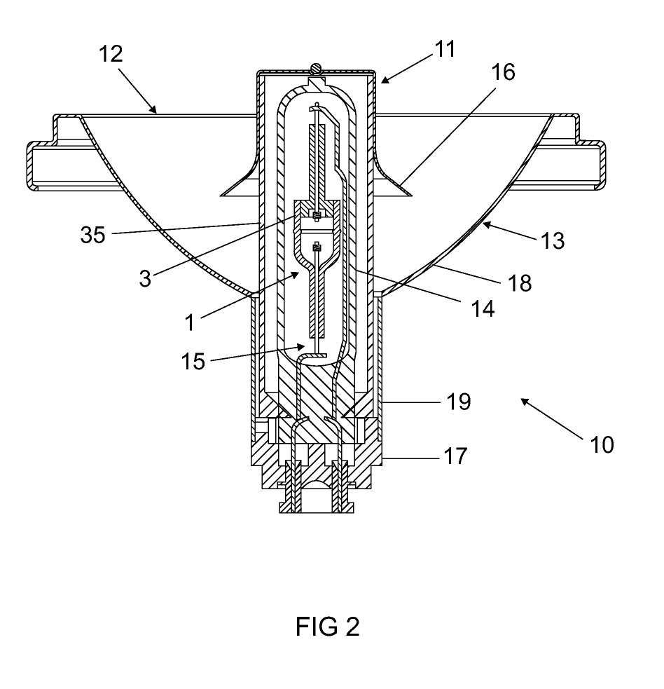

FIG. 2 shows a reflector lamp 10 with dazzle protection 11. In this embodiment, the blunt end 3 of the discharge vessel 1 is oriented toward the opening 12 of the reflector 13. The discharge vessel 1 is enclosed by an outer bulb 14 and held therein by means of a frame 15. As explosion protection, the outer bulb 14 is also enclosed by a glass envelope 35, essentially a cylindrical tube, on which a dazzle protection cap 16 is placed on the opening side. On the other end from the opening, there is a base 17 which, besides the fitted lamp, supports a metal reflector contour 18 including a neck 19.

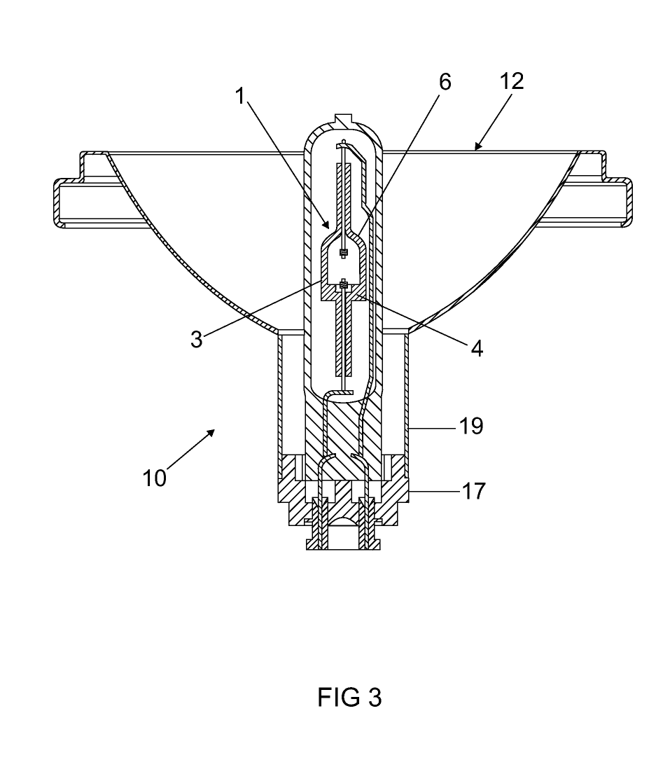

A lamp of this structure is provided with particular advantages owing to the fact that it can also be used in a reflector lamp 10 without dazzle protection and an envelope, see FIG. 3. To this end, it is sufficient to incorporate the discharge vessel 1 precisely the opposite way round into the reflector 13. The pointed end section 6 now faces toward the opening 12, and the blunt end section 3 toward the base 17. In this embodiment, the discharge vessel 1 is formed integrally without a seam. The stopper 4 is integral with the rest of the discharge vessel. In this case, the filling and the introduction of the second electrode are carried out through the stopper 4, to which end the capillary must be made wide enough. This is not additionally taken into account in the schematic drawing.

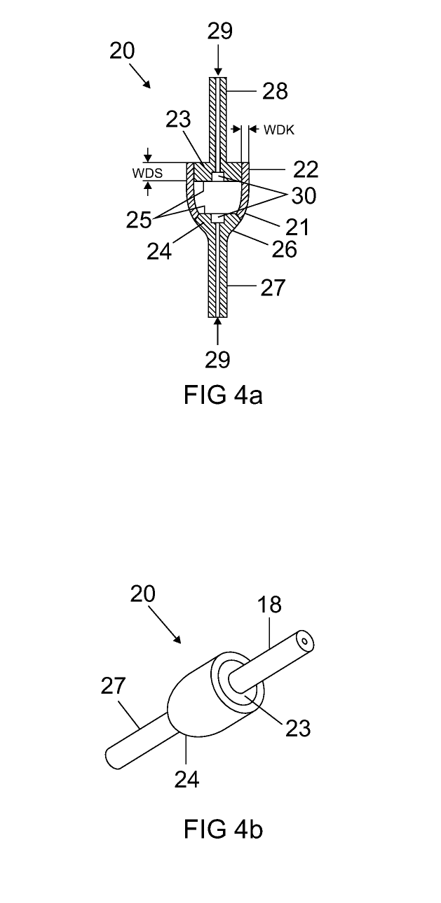

Lastly, FIG. 4 shows another embodiment of a discharge lamp. The ceramic discharge vessel 20 may be made of Al₂O₃, as is known per se, and may contain additives. Other ceramics such as sapphire, Dy₂O₃ or AlN may likewise be used.

In this embodiment, the discharge vessel 20 basically has a conical shape. That is to say the diameter increases continuously from the pointed end section 21 to the blunt end section 22, or as far as a certain point before the blunt end section. In this embodiment, the discharge vessel has two asymmetric stoppers 23 and 24, and in this case the pointed end section 21 may e.g. be shaped as a circle segment, a parabola segment or with a freeform contour.

The blunt stopper 23 is shaped as a circular ring, as is known per se. Although the pointed stopper 24 also has a straight end face 25 like the blunt stopper, it has a side wall 26 which is chamfered outward. The capillary 27 is formed integrally on the stopper.

The two capillaries 27, 28 are formed integrally on the stoppers 23, 24 and contain a bore 29 for the electrodes and feed-throughs. A blind hole 30 is recessed in the direction of the discharge.

The inner diameter of the discharge vessel should e.g. increase by from 5 to 35% from end face to end face; for reasons of stabilizing the discharge, a taper in the range of from 10 to 25% is particularly advantageous.

The blunt stopper 23 may optionally have a greater wall thickness WDS than the bulb body, the wall thickness of which is WDK. The following should apply: WDS is at least equal to WDK, and in various embodiments: WDS is up to 3 times as thick as WDK. The blunt stopper may in various embodiments have a so-called top-hat design, i.e. a bearing surface for the open end of the discharge vessel.

The bulb, including the capillaries, may be in one, two or even more parts.

Owing to the possible features described above, there are a multiplicity of embodiments which can be tailored to each desired application. One possible application of a metal halide lamp including an asymmetric bulb is direct fitting into a light. The latter need not necessarily have a reflector, since this type of fitted lamp can resolve all possible thermal problems in a light.

The emission for reflector lamps is optimized by suitable shaping of the bulb body. Furthermore, the formation of color inhomogeneities can be reduced by controlled formation of the cold spot 9, which does not lie in the main beam path of the light, in the corner of the blunt stopper, so that a problem which has long been unsatisfactorily solved by other means can finally be resolved. According to various embodiments, this problem is no longer carefully concealed by configuration of the reflector, but actually solved.

In metal halide reflector lamps without a dazzle protection system, see FIG. 3, the blunt stopper 23 is for example oriented toward the reflector neck. This reduces the radiation into the reflector neck 19 and keeps the condensate outside the desired emission region. Toward the reflector opening 8, the discharge vessel is formed spherically, ovally or as a freeform line adapted to the reflector contour, in order to permit maximally homogeneous emission into the useful region of the reflector.

In reflector lamps with dazzle protection systems, see FIG. 2, such a bulb ceramic is mounted with the blunt stopper in the direction of the dazzle protection. The advantages for the reflector neck region, however, are thereby lost.

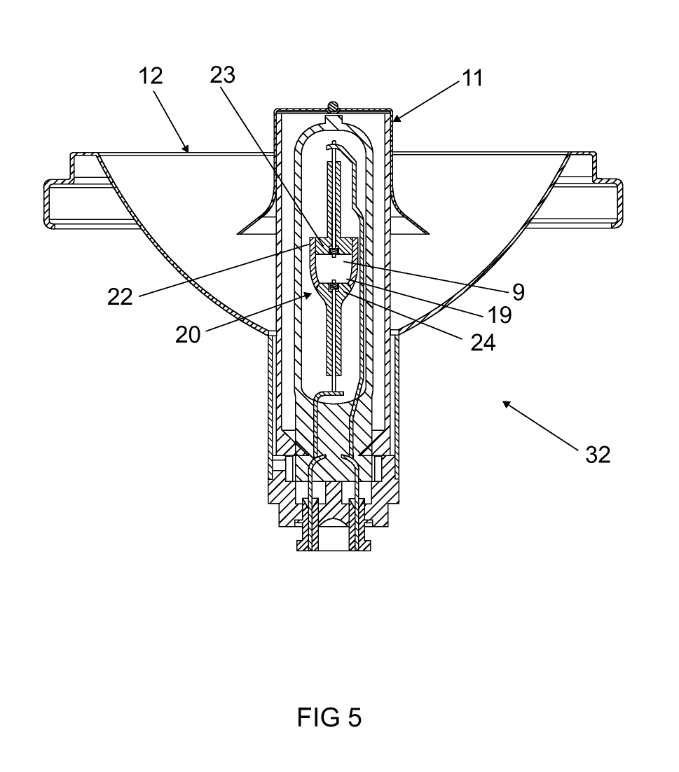

Another embodiment, FIG. 5, is a reflector lamp 32 including the discharge vessel of FIG. 4. It has a bulb ceramic which includes two stoppers. The discharge vessel has a pointed end section, which corresponds in particular to a sphere segment, a cone with a parabolic curve or a freeform line. The radiation loss into the reflector neck and dazzle protection system can be reduced by means of this, so that a cold spot 9 is formed outside the main radiation region. The blunt end section faces toward the opening of the reflector. The pointed stopper 24 does in fact also have a corner 19 owing to its flat end face 25. Yet since the radial distance to the electrode is in this case much less than in the blunt stopper 23, the cold spot is nevertheless uniquely established.

Known metal halide systems such as rare earth metal halides, Na iodide, Ca iodide, thallium iodide etc., with or without Hg, and noble gas are suitable as the fill.

In various embodiments, a metal halide discharge lamp is provided having a ceramic discharge vessel containing a metal halide fill, including a tubular central part and two end sections which are configured asymmetrically, in each of which an electrode system is held, wherein a pointed first end section tapers as seen from the central part, while a blunt second end section either remains constant in its dimensions or widens as seen from the central part, a stopper being fitted at least in the blunt end.

In an implementation of various embodiments, the central part may be cylindrical, the blunt end section keeping the diameter of the central part.

In an implementation of various embodiments, the pointed end section may have a contour which tapers as a segment of a sphere, an ellipsoid or a paraboloid.

In an implementation of various embodiments, the diameter of the discharge vessel may increase continuously or in sections from the pointed end section to the blunt end section.

In an implementation of various embodiments, the pointed end section may be produced with the aid of a stopper.

In an implementation of various embodiments, the pointed stopper may have side walls inclined obliquely outward.

In an implementation of various embodiments, the lamp may be incorporated in a reflector.

In an implementation of various embodiments, the reflector may have no dazzle protection.

In various embodiments, a light may be provided having a metal halide discharge lamp in accordance with various embodiments as described above.

In an implementation of various embodiments, In an implementation of various embodiments, In an implementation of various embodiments,

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A metal halide discharge lamp, comprising:
a ceramic discharge vessel containing a metal halide fill, including a tubular central part and two end sections which are configured asymmetrically, in each of which an electrode system is held,
wherein a pointed first end section tapers as seen from the central part, while a blunt second end section either remains constant in its dimensions or widens as seen from the central part, a stopper being fitted at least in the blunt end.

2. The metal halide discharge lamp as claimed in claim 1,
wherein the central part is cylindrical, the blunt end section keeping the diameter of the central part.

3. The metal halide discharge lamp as claimed in claim 1,
wherein the pointed end section has a contour which tapers as a segment of a sphere, an ellipsoid or a paraboloid.

4. The metal halide discharge lamp as claimed in claim 1,
wherein the diameter of the discharge vessel increases continuously or in sections from the pointed end section to the blunt end section.

5. The metal halide discharge lamp as claimed in claim 1,
wherein the pointed end section is produced with the aid of a stopper.

6. The metal halide discharge lamp as claimed in claim 1,
wherein the pointed stopper has side walls inclined obliquely outward.

7. The metal halide discharge lamp as claimed in claim 1,
wherein the lamp is incorporated in a reflector.

8. The metal halide discharge lamp as claimed in claim 1,
wherein the reflector has no dazzle protection.

9. A light comprising a metal halide discharge lamp, the metal halide discharge lamp comprising:
a ceramic discharge vessel containing a metal halide fill, including a tubular central part and two end sections which are configured asymmetrically, in each of which an electrode system is held,
wherein a pointed first end section tapers as seen from the central part, while a blunt second end section either remains constant in its dimensions or widens as seen from the central part, a stopper being fitted at least in the blunt end.
